(19) United States
(12) Patent Application Publication
(10) Pub. No.: US 2010/0319895 A1
(43) Pub. Date: Dec. 23, 2010

(54) HEAT SPREADER STRUCTURE AND METHOD OF MANUFACTURING THE SAME

(76) Inventors: Wei-En Chen, Taipei City (TW); Ying-Tung Chen, Taoyuan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/488,060

(22) Filed: Jun. 19, 2009

(51) Int. Cl. F28F 21/02; B05D 3/02; B05D 7/00; C04B 37/02; F28F 21/08; B21D 53/02

(52) U.S. Cl. 165/185; 427/376.1; 427/217; 156/89.25; 29/890.03

(57) ABSTRACT

A heat spreader structure includes at least one carbonaceous matter-metal composite layer having a plurality of carbonaceous particles and at least one metal-mesh layer having a plurality of meshes. The carbonaceous particles are either separately firmly held inside the meshes of the metal-mesh layer or covered and held in place by the metal-mesh layer. The carbonaceous matter-metal composite layer can be coated on a metal-made body through sintering to ensure good bonding of the carbonaceous particles to the metal-made body and accordingly enhance the heat spreading efficiency of the metal-made body. A method for manufacturing the heat spreader structure is also disclosed.

### FIELD OF THE INVENTION

The present invention relates to a heat spreader structure, and more particularly, to a heat spreader structure providing excellent heat spreader performance; and the present invention also relates to a method of manufacturing the heat spreader structure.

### BACKGROUND OF THE INVENTION

The heat produced by electronic elements in various electronic devices increases with the increasing computing speed and data processing capability of the electronic devices. The heat produced by the electronic elements during the operation thereof must be timely removed, lest the heat should adversely affect the operation efficiency of the electronic devices to even cause burnout of the electronic elements thereof. According to a conventional way of removing such heat, a cooling unit is provided on a top of an electronic element. In most cases, the conventional cooling unit is a radiation fin assembly or a heat sink. In some cases, the conventional cooling unit further includes heat pipes that are extended through a main body of the cooling unit and between the main body and the heat source, so as to enhance the heat transfer and heat dissipation performance of the cooling unit.

Currently, due to its high heat transfer speed, heat pipe has been widely applied in the electronic field for dissipating heat produced by electronic elements during the operation thereof. The commonly adopted heat pipe includes a sealed tubular housing having a predetermined vacuum tightness. The tubular housing is internally provided with a capillary structure obtained through sintering, and has an adequate amount of working fluid filled therein. An end of the heat pipe is a vaporizing end, and the other end of the heat pipe is a condensing end. When the vaporizing end is heated, the working fluid absorbs heat and evaporates to vapor. Under the small difference in pressure, the vapor migrates to the condensing end to release heat and condenses back to liquid. Due to a capillary pressure difference produced by the capillary structure, the liquid flows back to the vaporizing end of the heat pipe. Therefore, with the above arrangements, heat can be quickly transferred from the vaporizing end to the condensing end of the heat pipe. However, the work performance of the heat pipe is subject to two factors, that is, capillary pressure difference and backflow resistance. These two factors change with the size of capillary porosity of the capillary structure. When the capillary porosity is small, the capillary pressure difference is large and sufficient for driving the condensed working fluid into the capillary structure to flow back to the vaporizing end. However, the small capillary porosity will also increase the frictional force to cause frictional flow of the working fluid when flowing back to the vaporizing end. The large backflow resistance to the working fluid will result in slow backflow speed of the working fluid and dry burning of the heat pipe at the vaporizing end. On the other hand, when the capillary porosity is large, the working fluid is subject to relatively low backflow resistance, and capillary pressure difference for sucking the condensed liquid into the capillary structure is small, too. Under this condition, the quantity of back flow of the working fluid is also reduced to cause dry burning at the vaporizing end. Since the capillary structure in the heat pipe is formed by bonding copper powder to the inner wall surface of the heat pipe through sintering in powder metallurgy, and the sintered capillary structure contains pores, the bonding strength between the copper powder and the inner wall surface of the heat pipe is low, and the copper powder tends to separate from and scatter in the heat pipe when the heat pipe is subjected to external force and becomes bent, resulting in lowered heat transfer performance of the heat pipe. That is, the conventional capillary structure in the heat pipe fails to bear the heat energy produced by a high-power central processing unit.

To overcome the above-mentioned drawback, artificial diamond having high thermal coefficient has been used as a structural material to help in increasing heat spreading and heat transfer performance of the heat pipe. The industrial diamond has a thermal conductivity as high as 2300 (W/m·K), which is much higher compared to the thermal conductivity of 401 (W/m·K) of copper material. While a heat spreader structure made of artificial diamond provides effectively upgraded heat spreading efficiency, it is highly restricted by various conditions and factors, such as difficult material deposition and manufacturing process of artificial diamond and accordingly requires considerably high manufacturing cost. For example, when using chemical vapor deposition to form a layer of artificial diamond coating on a desired workpiece, the size and the melting point of the material of the workpiece all have influence on the forming of the artificial diamond coating. The artificial diamond coating just could not be formed on a material with a large area and low melting point. In this case, artificial diamond particles or powder must be mixed with other dissimilar materials and sintered for use. However, the bonding strength between the artificial diamond powder and other dissimilar materials is low. For instance, even when the artificial diamond material is bonded to a type of metal powder through sintering in powder metallurgy, the artificial diamond material will eventually separate from the metal powder due to its poor bonding power.

In brief, the conventional heat spreader structures for coating on a heat-transfer metal body have the following disadvantages: (1) poor bonding power; (2) high manufacturing cost; (3) low thermal transfer performance; and (4) subject to a lot of limitations in machining or processing the material.

It is therefore desirable to develop a heat spreader structure and a method for manufacturing the same, so that the heat spreader structure can provide good heat spreading effect, has simple structure, and can be easily manufactured at reduced cost to overcome the drawbacks in the prior art.

### SUMMARY OF THE INVENTION

A primary object of the present invention is to provide a heat spreader structure having excellent heat spreading performance.

Another object of the present invention is to provide a method of manufacturing a heat spreader structure having excellent heat spreading performance.

A further object of the present invention is to provide a heat spreader structure with which carbonaceous particles can firmly bond to a metal body to ensure good heat spreading efficiency.

To achieve the above and other objects, the heat spreader structure according to an embodiment of the present invention includes at least one carbonaceous matter-mesh composite layer including a plurality of carbonaceous particles and at least one metal-mesh layer having a plurality of meshes. The carbonaceous particles can be separately firmly held inside the meshes or be covered and held in place by the metal-mesh layer. The carbonaceous particles can be selected from the group consisting of diamond and graphite particles. The carbonaceous matter-metal composite layer can be used with at least one metal-made body by attaching the carbonaceous matter-metal composite layer to one face of the metal-made body. Alternatively, the carbonaceous matter-metal composite layer can be used with a metal-made body internally defining a chamber by attaching the carbonaceous matter-metal composite layer to an inner wall face or inner wall faces of the chamber of the metal-made body.

The heat spreader structure according to another embodiment of the present invention includes at least one carbonaceous matter-metal composite layer including a plurality of carbonaceous particles and at least one metal-mesh layer having a plurality of meshes. The carbonaceous particles are externally coated with at least one layer of metal coating, and are either separately firmly held inside the meshes or covered and held in place by the metal-mesh layer. The carbonaceous particles can be selected from the group consisting of diamond and graphite particles. The metal coating is formed using a material selected from the group consisting of copper, aluminum, and silver. The carbonaceous matter-metal composite layer can be used with at least one metal-made body by attaching the carbonaceous matter-metal composite layer to one face of the metal-made body. Alternatively, the carbonaceous matter-metal composite layer can be used with a metal-made body internally defining a chamber by attaching the carbonaceous matter-metal composite layer to an inner wall face or inner wall faces of the chamber of the metal-made body.

The heat spreader structure according to a further embodiment of the present invention includes at least one carbonaceous matter-metal composite layer including a plurality of carbonaceous particles, at least one metal-mesh layer having a plurality of meshes, and a plurality of metal particles having high thermal conductivity; The carbonaceous particles are mixed homogeneously with the metal particles having high thermal conductivity, and the mixture of the carbonaceous particles and the metal particles is covered and thereby held in place by the metal-mesh layer. The carbonaceous particles can be selected from the group consisting of diamond and graphite particles. The metal particles having high thermal conductivity can be selected from the group consisting of copper, aluminum, silver, and nickel particles. The carbonaceous matter-metal composite layer can be used with at least one metal-made body by attaching the carbonaceous matter-metal composite layer to one face of the metal-made body. Alternatively, the carbonaceous matter-metal composite layer can be used with a metal-made body internally defining a chamber by attaching the carbonaceous matter-metal composite layer to an inner wall face or inner wall faces of the chamber of the metal-made body.

The heat spreader structure according to a still further embodiment of the present invention includes at least one carbonaceous matter-metal composite layer including a plurality of carbonaceous particles, at least one metal-mesh layer having a plurality of meshes, and a plurality of metal particles having high thermal conductivity. The carbonaceous particles are externally coated with at least one layer of metal coating, and are mixed homogeneously with the metal particles having high thermal conductivity, and the mixture of the carbonaceous particles and the metal particles is covered and thereby held in place by the metal-mesh layer. The carbonaceous particles can be selected from the group consisting of diamond and graphite particles. The metal coating is formed using a material selected from the group consisting of copper (Cu), aluminum (Al), and silver (Ag). The metal particles having high thermal conductivity are selected from the group consisting of copper, aluminum, silver, and nickel particles. The carbonaceous matter-metal composite layer can be used with at least one metal-made body by attaching the carbonaceous matter-metal composite layer to one face of the metal-made body. Alternatively, the carbonaceous matter-metal composite layer can be used with a metal-made body internally defining a chamber by attaching the carbonaceous matter-metal composite layer to an inner wall face or inner wall faces of the chamber of the metal-made body.

To achieve the above and other objects, the method of manufacturing the heat spreader structure according to an embodiment of the present invention includes the following steps: providing at least one metal-made body, at least one metal-mesh layer having a plurality of meshes, and a plurality of carbonaceous particles; pressing the carbonaceous particles into the meshes of the metal-mesh layer to form a carbonaceous matter-metal composite layer; and coating the carbonaceous matter-metal composite layer on one face of the metal-made body, and sintering the carbonaceous matter-metal composite layer and the metal-made body for them to firmly bond to each other. According to another embodiment of the present invention, the above-described method can further include a step before the pressing step to coat at least one layer of metal coating on outer faces of the carbonaceous particles; and a step before the coating step to form a carbonized layer on the outer faces of the carbonaceous particles. The carbonized layer can be formed using a material selected from the group consisting of chromium (Cr), titanium (Ti), tungsten (W), molybdenum (No), silicon (Si), and vanadium (V); the material for forming the metal coating can be selected from the group consisting of copper (Cu), aluminum (Al), and silver (Ag); and the carbonaceous particles can be selected from the group consisting of diamond particles and graphite particles. Moreover, according to a still further embodiment of the present invention, the above-described method can further include a step before the pressing step and after the coating step to evenly mix the carbonaceous particles with a plurality of metal particles having high thermal conductivity.

To achieve the above and other objects, the method of manufacturing the heat spreader structure according to a further embodiment of the present invention includes the following steps: providing at least one metal-made body, at least one metal-mesh layer, and a plurality of carbonaceous particles; evenly distributing the carbonaceous particles on the metal-made body at predetermined deposition areas; using the metal-mesh layer to cover and thereby hold the evenly distributed carbonaceous particles in place to form a carbonaceous matter-metal composite layer; and causing the carbonaceous matter-metal composite layer to bond to the metal-made body through sintering. According to a still further embodiment of the present invention; the above-described method can further include a step before the evenly distributing step to coat at least one layer of metal coating on outer faces of the carbonaceous particles; and a step before the coating step to form a carbonized layer on the outer faces of the carbonaceous particles. The carbonized layer can be formed using a material selected from the group consisting of chromium (Cr), titanium (Ti), tungsten (W) molybdenum (Mo), silicon (Si), and vanadium (V); the material for forming the metal coating can be selected from the group consisting of copper (Cu), aluminum (Al), and silver (Ag); and the carbonaceous particles can be selected from the group consisting of diamond particles and graphite particles. Moreover, according to a still further embodiment of the present invention, the above-described method can further include a step before the evenly distributing step and after the coating step to evenly mix the carbonaceous particles with a plurality of metal particles having high thermal conductivity.

With the heat spreader structure and the method of manufacturing the same according to the present invention, the meshes of the metal-mesh layer have a mesh size smaller than a particle size of the carbonaceous particles. Therefore, no matter the carbonaceous particles are pressed to be firmly held inside the meshes or simply covered and held in place by the metal-mesh layer, the carbonaceous particles can always stably and firmly associate with the metal-mesh layer without the risk of separating therefrom. Therefore, the problem of poor bonding power of the diamond particles as found in the prior art can be solved. Meanwhile, the carbonaceous matter-metal composite layer including the carbonaceous particles and the metal-mesh layer can be coated on or attached to the face of any metal material.

Therefore, the heat spreader structure of the present invention provides at least the following advantages: (1) good bonding power; (2) excellent heat spreading performance; (3) reduced manufacturing cost; and (4) simplified manufacturing process.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a metal-mesh layer for forming a heat spreader structure of the present invention;

FIG. 2 is a perspective view of a carbonaceous matter-metal composite layer forming the heat spreader structure of the present inventions;

FIG. 3A is a sectional view of a first form of the carbonaceous matter-metal composite layer according to the present invention;

FIG. 3B is a sectional view of a second form of the carbonaceous matter-metal composite layer according to the present invention;

FIG. 4 is a fragmentary sectional view showing a first example of application of the heat spreader structure according to a first embodiment of the present invention;

FIG. 4A is an enlarged view of the circled area 4A of FIG. 4;

FIG. 5 is a sectional view showing a second example of application of the heat spreader structure according to the first embodiment of the present invention;

FIG. 5A is an enlarged view of the circled area 5A of FIG. 5;

FIG. 5B is a fragmentary sectional view showing a third example of application of the heat spreader structure according to the first embodiment of the present invention;

FIG. 5C is an enlarged view of the circled area 5C of FIG. 5B;

FIG. 6 is a sectional view of a carbonaceous matter-metal composite layer forming the heat spreader structure according to a second embodiment of the present invention;

FIG. 7 is a fragmentary sectional view showing a first example of application of the heat spreader structure according to the second embodiment of the present invention;

FIG. 7A is an enlarged view of the circled area 7A of FIG. 7;

FIG. 8 is a sectional view showing a second example of application of the heat spreader structure according to the second embodiment of the present invention;

FIG. 8A is an enlarged view of the circled area 8A of FIG. 8;

FIG. 8B is a fragmentary sectional view showing a third example of application of the heat spreader structure according to the second embodiment of the present invention;

FIG. 8C is an enlarged view of the circled area 8C of FIG. 8B;

FIG. 9 is a fragmentary sectional view showing a first example of application of the heat spreader structure according to a third embodiment of the present invention;

FIG. 9A is an enlarged view of the circled area 9A of FIG. 9;

FIG. 10 is a sectional view showing a second example of application of the heat spreader structure according to the third embodiment of the present invention;

FIG. 10A is an enlarged view of the circled area 10A of FIG. 10;

FIG. 10B is a fragmentary sectional view showing a third example of application of the heat spreader structure according to the third embodiment of the present invention;

FIG. 10C is an enlarged view of the circled area 10C of FIG. 10B;

FIG. 11 is a fragmentary sectional view showing a first example of application of the heat spreader structure according to a fourth embodiment of the present invention;

FIG. 11A is an enlarged view of the circled area 11A of FIG. 11;

FIG. 12 is a sectional view showing a second example of application of the heat spreader structure according to the fourth embodiment of the present invention;

FIG. 12A is an enlarged view of the circled area 12A of FIG. 12;

FIG. 12B is a fragmentary sectional view showing a third example of application of the heat spreader structure according to the fourth embodiment of the present invention;

FIG. 12C is an enlarged view of the circled area 12C of FIG. 12B;

FIG. 13 is a flowchart showing the steps included in a method of manufacturing heat spreader structure according to a first embodiment of the present invention;

FIG. 14 is a flowchart showing the steps included in a method of manufacturing heat spreader structure according to a second embodiment of the present invention;

FIG. 15 is a flowchart showing the steps included in a method of manufacturing heat spreader structure according to a third embodiment of the present invention;

FIG. 16 is a flowchart showing the steps included in a method of manufacturing heat spreader structure according to a fourth embodiment of the present invention;

FIG. 17 is a sectional view of the heat spreader structure manufactured according to the method according to the second embodiment of the present invention; and

FIG. 18 is a sectional view of the heat spreader structure manufactured according to the method according to the fourth embodiment of the present invention.

### DETAILED DESCRIPTION OF THE PREFERRED EMBODIMENTS

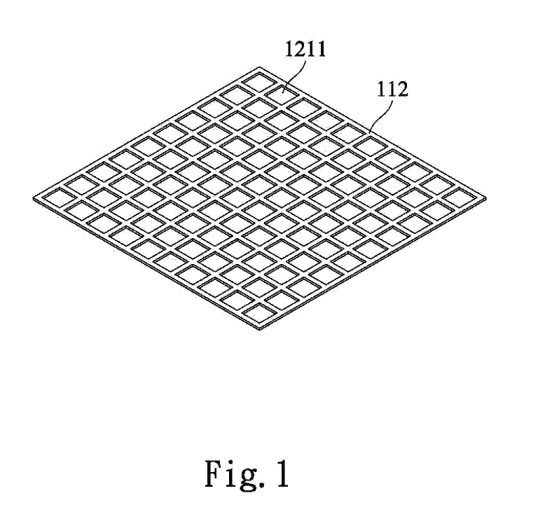

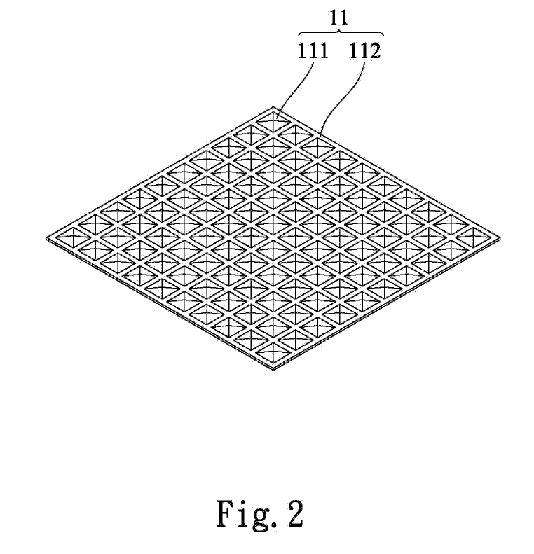

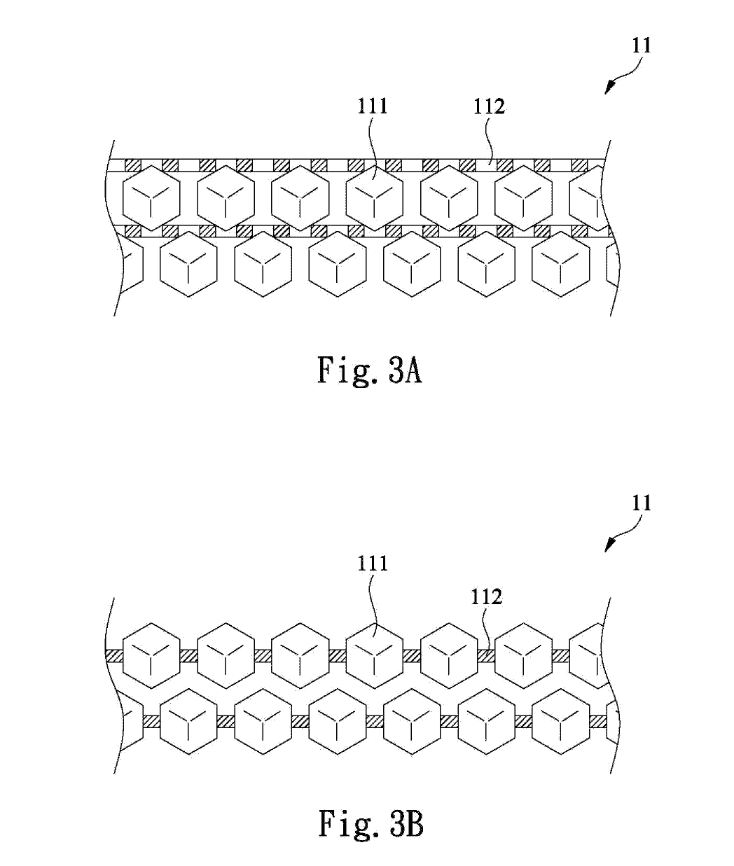

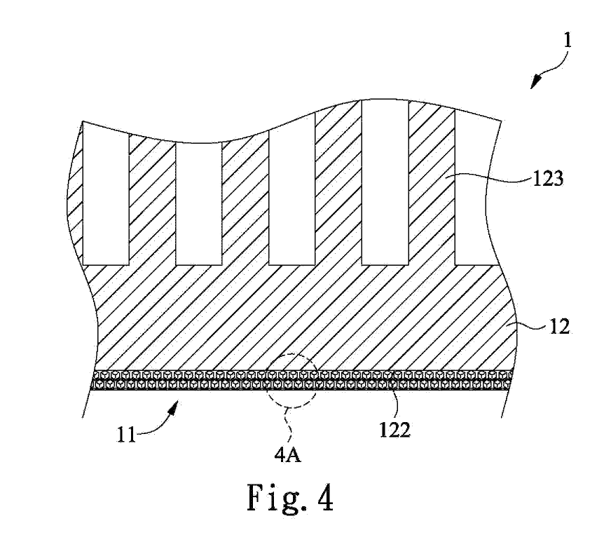

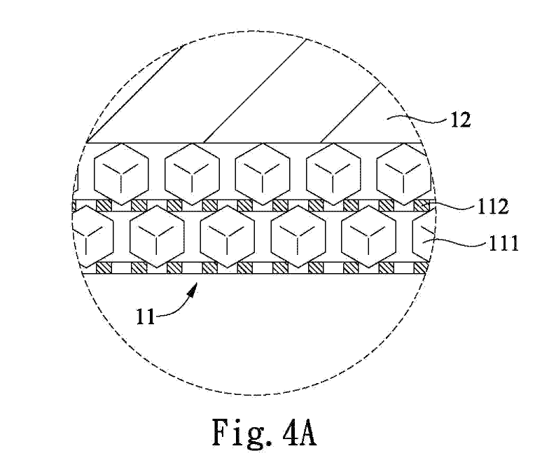

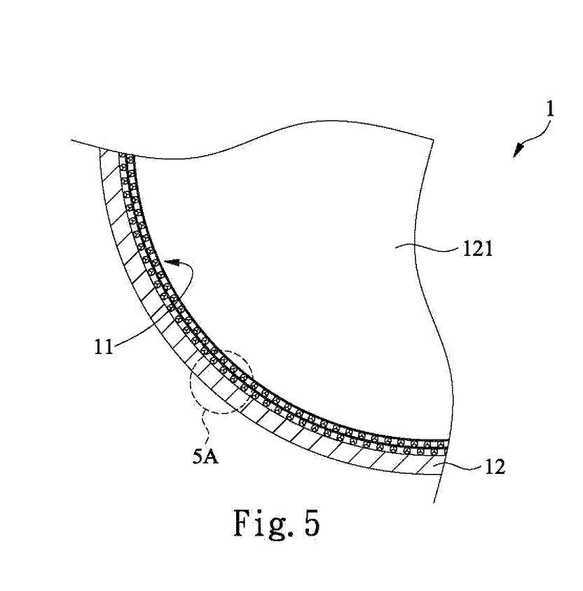

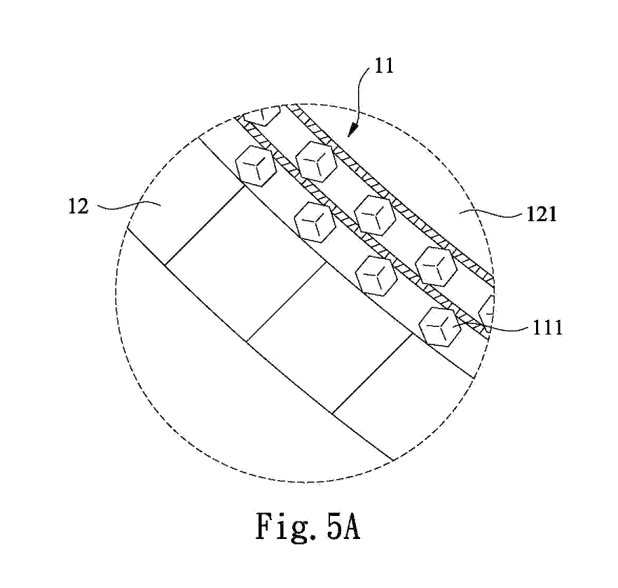

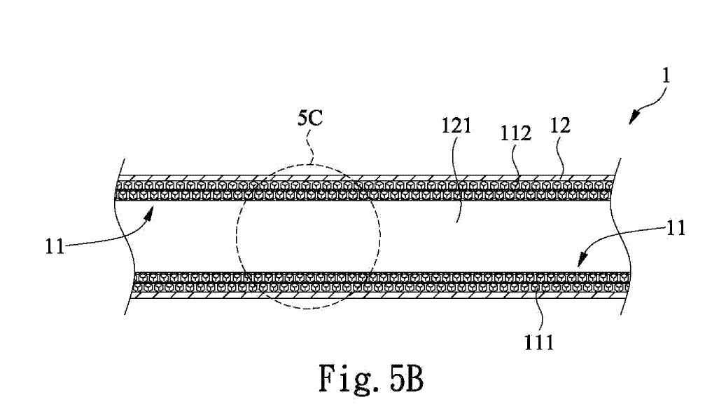

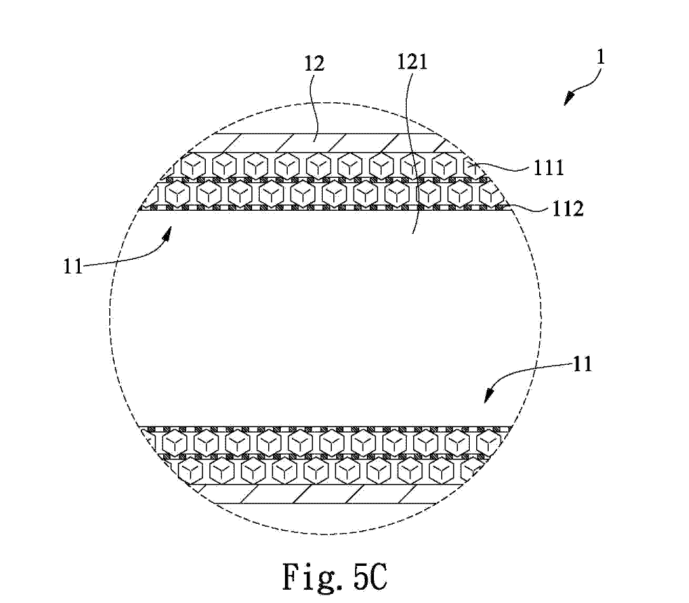

Please refer to FIGS. 1, 2, 3A-B, 4, 4A, 5, and 5A-C. A heat spreader structure 1 according to a first embodiment of the present invention includes at least one carbonaceous matter-metal composite layer 11 including a plurality of carbonaceous particles 111 and at least one metal-mesh layer 112. The metal-mesh layer 112 has a plurality of meshes 1121, and can be made of a material selected from the group consisting of copper (Cu), aluminum (Al), silver (Ag), and Nickel (Ni). In a first form of the carbonaceous matter-metal composite layer 11, the carbonaceous particles 111 are separately firmly held inside the meshes 1121 of the metal-mesh layer 112, as shown in FIG. 3B. In a second form of the carbonaceous matter-metal composite layer 11, the carbonaceous particles 111 are covered and held in place by the metal-mesh layer 112, as shown in FIG. 3A. The carbonaceous particles 111 are selected from the group consisting of diamond and graphite particles. In a first example of application, the carbonaceous matter-metal composite layer 11 forming the beat spreader structure 1 is used with at least one metal-made body 12, which is configured as a heat sink, as shown in FIGS. 4 and 4A. In this case, the carbonaceous matter-metal composite layer 11 is coated on or attached to an outer face of the metal-made body 12. In a second example of application, the carbonaceous matter-metal composite layer 11 is used with a hollow metal-made body 12 internally defining a chamber 121, such as a heat pipe, as shown in FIGS. 5 and 5B. In this case, the carbonaceous matter-metal composite layer 11 is attached to an inner wall surface of the chamber 121 of the metal-made body 12. The carbonaceous matter-metal composite layer 11 including the carbonaceous particles 111 and the at least one metal-mesh layer 112 can include only one single ply or multiple overlaid plies. Either the single-ply or the multiply carbonaceous matter-metal composite layer 11 can be coated on the outer face of the metal-made body 12 or the inner wall surface of the chamber 121 of the metal-made body 12. Alternatively, in a third example of application, the carbonaceous matter-metal composite layer 11 is used with a metal-made body 12 configured as a flat heat pipe, as shown in FIGS. 5B and 5C. In this case, the carbonaceous matter-metal layer 11 is attached to inner wall surfaces 121 of the metal-made body 12, and the carbonaceous matter-metal composite layer 11 including the carbonaceous particles 111 and the at least one metal-mesh layer 112 can include only one single ply or multiple plies.

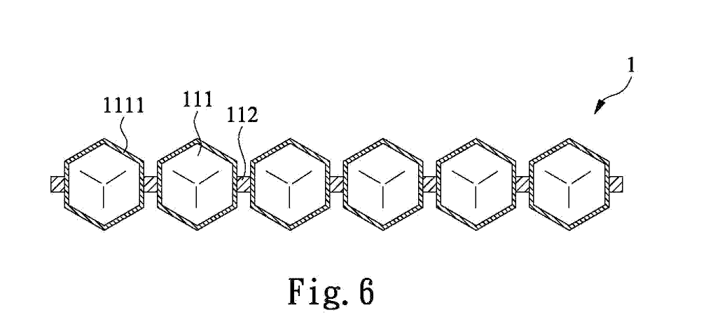

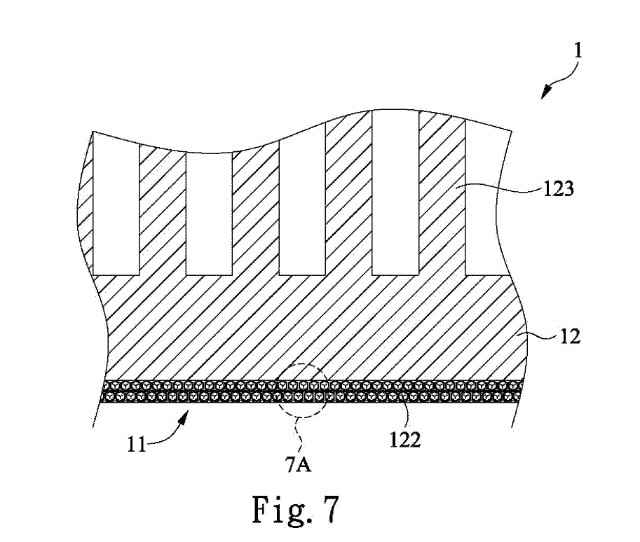

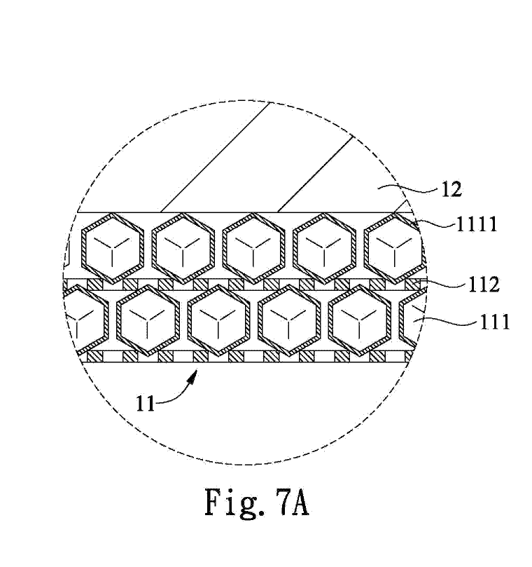

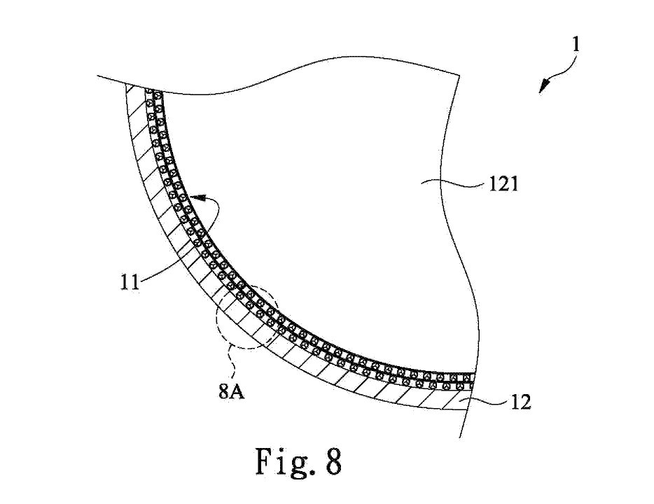

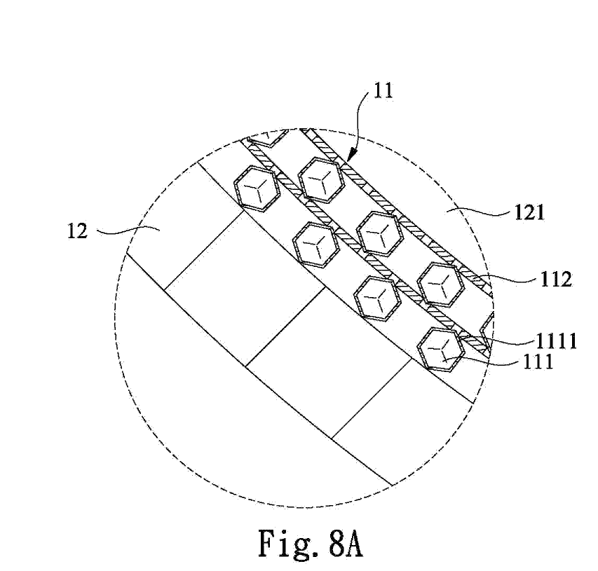

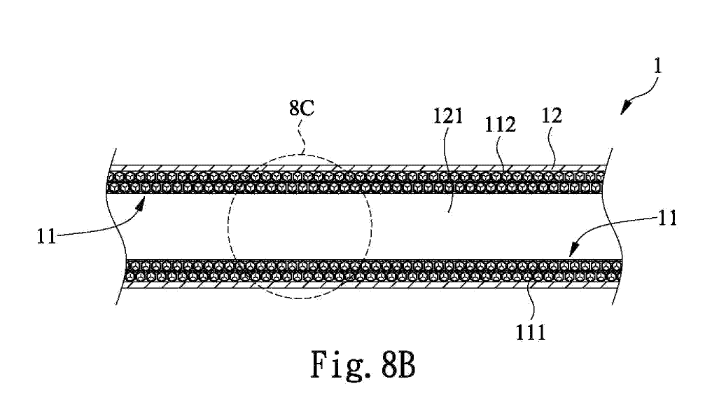

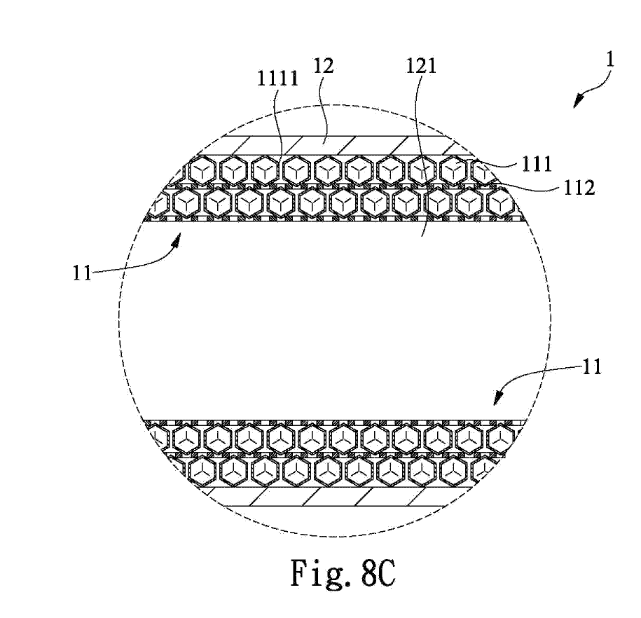

Please refer to FIGS. 1, 2, 6, 7, 7A, 8, and 8A-C. A heat spreader structure 1 according to a second embodiment of the present invention includes at least one carbonaceous matter-metal composite layer 11 including a plurality of carbonaceous particles 111 and at least one metal-mesh layer 112. In the second embodiment, the carbonaceous particles 111 are externally coated with at least one layer of metal coating 1111. The metal-mesh layer 112 has a plurality of meshes 1121, and can be made of a material selected from the group consisting of copper (Cu), aluminum (Al), silver (Ag), and nickel (Ni). The carbonaceous particles 111 can be separately firmly held inside the meshes 1121 of the metal-mesh layer 112, as shown in FIG. 6, or be covered and held in place by the metal-mesh layer 112, as shown in FIG. 3A. The carbonaceous particles 111 are selected from the group consisting of diamond and graphite particles. The metal coating 1111 is formed using a material selected from the group consisting of copper (Cu), aluminum (Al), and silver (Ag). In a first example of application, the heat spreader structure 1 of the second embodiment is used with at least one metal-made body 12, which is configured as a heat sink, as shown in FIGS. 7 and 7A. In this case, the carbonaceous matter-metal composite layer 11 is attached to an outer face of the metal-made body 12. In a second and a third example of application, the heat spreader structure 1 of the second embodiment is used with a hollow metal-made body 12 configured as a heat pipe and a flat heat pipe, respectively, which internally defines a chamber 121, such as shown in FIGS. 8 and 8A and FIGS. 8B and 8C, respectively. In these cases, the carbonaceous matter-metal composite layer 11 is attached to an inner wall surface or inner wall surfaces of the chamber 121 of the metal-made body 12. The carbonaceous matter-metal composite layer 11 including the carbonaceous particles 111 with metal coating 1111 and the at least one metal-mesh layer 112 can include only one single ply or multiple overlaid plies. The carbonaceous matter-metal composite layer 11 is then coated on the outer face of the metal-made body 12 or the inner wall surface(s) of the chamber 121 of the metal-made body 12.

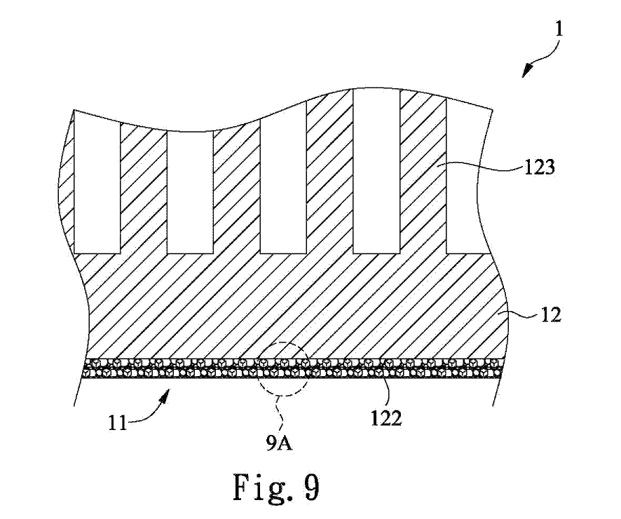

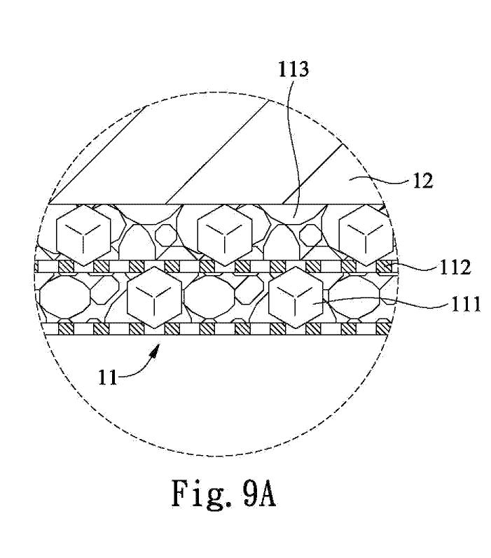

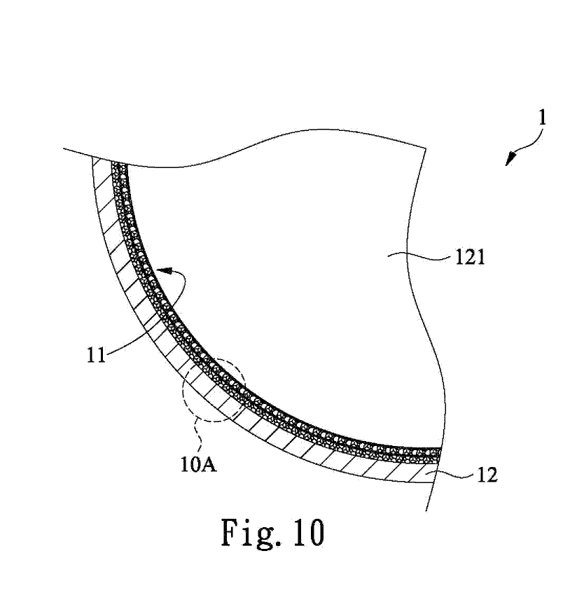

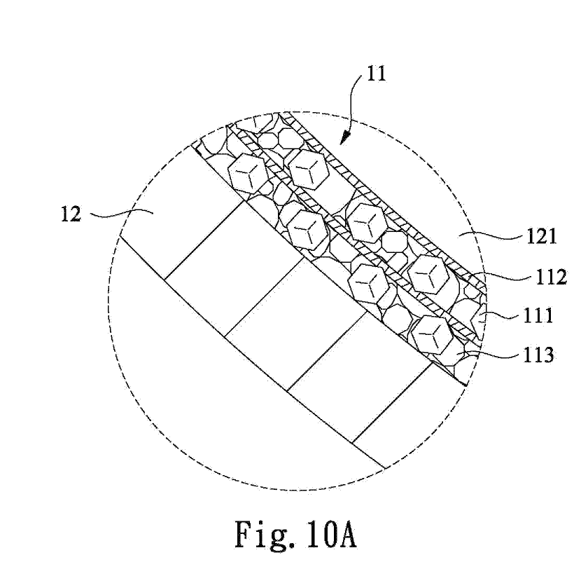

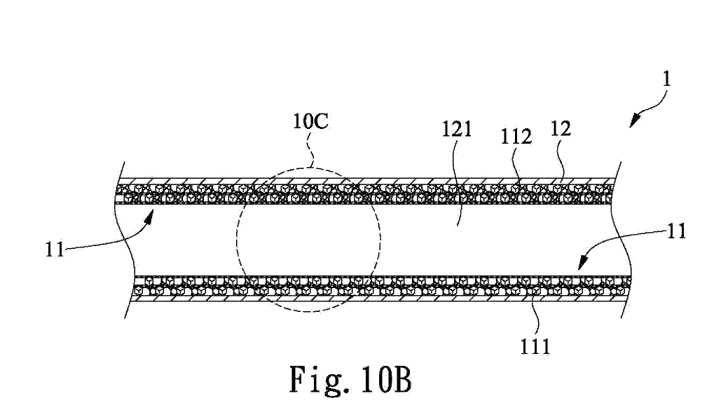

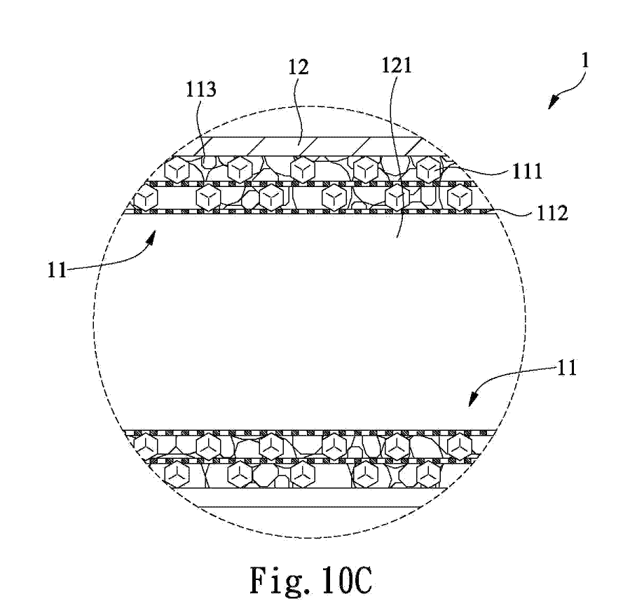

Please refer to FIGS. 1, 2, 9, 9A, 10 and 10A-C. A heat spreader structure 1 according to a third embodiment of the present invention includes at least one carbonaceous matter-metal composite layer 11 including a plurality of carbonaceous particles 111, at least one metal-mesh layer 112, and a plurality of metal particles 113 having high thermal conductivity. The metal particles 113 having high thermal conductivity are selected from the group consisting of copper (Cu), aluminum (Al), silver (Ag), and nickel (Ni) particles, and are preferably copper particles. The metal-mesh layer 112 has a plurality of meshes 1121, and can be made of a material selected from the group consisting of copper (Cu), aluminum (Al), silver (Ag), and nickel (Ni). The carbonaceous particles 111 are mixed homogeneously with the metal particles 113 having high thermal conductivity and the mixture is covered and thereby held in place using the metal-mesh layer 112. And, the carbonaceous particles 111 can be selected from the group consisting of diamond and graphite particles. In a first example of application, the heat spreader structure 1 of the third embodiment is used with at least one metal-made body 12, which is configured as a heat sink, as shown in FIGS. 9 and 9A. In this case, the carbonaceous matter-metal composite layer 11 is attached to an outer face of the metal-made body 12. In a second and a third example of application, the heat spreader structure 1 of the third embodiment is used with a hollow metal-made body 12 configured as a heat pipe and a flat heat pipe, respectively, which internally defines a chamber 121, as shown in FIGS. 10 and 10A and FIGS. 10B and 10C, respectively. In these cases, the carbonaceous matter-metal composite layer 11 is attached to an inner wall surface or inner wall surfaces of the chamber 121 of the metal-made body 12. The carbonaceous matter-metal composite layer 11 coated on the outer face of the metal-made body 12 or on the inner wall surface(s) of the chamber 121 of the metal-made, body 12 can include only one single ply or multiple overlaid plies.

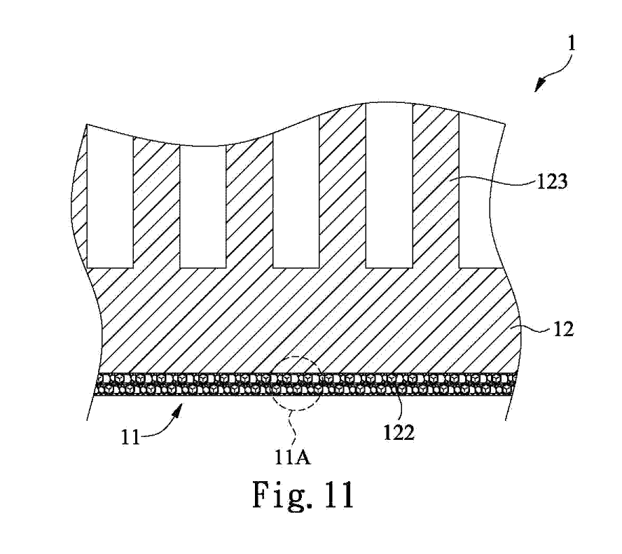

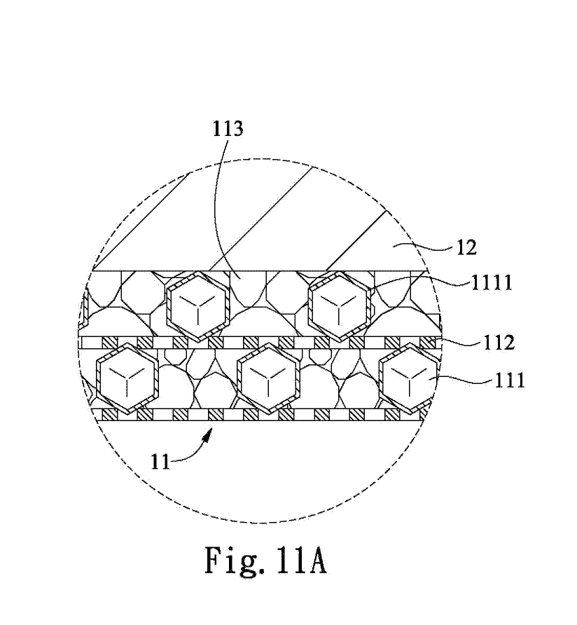

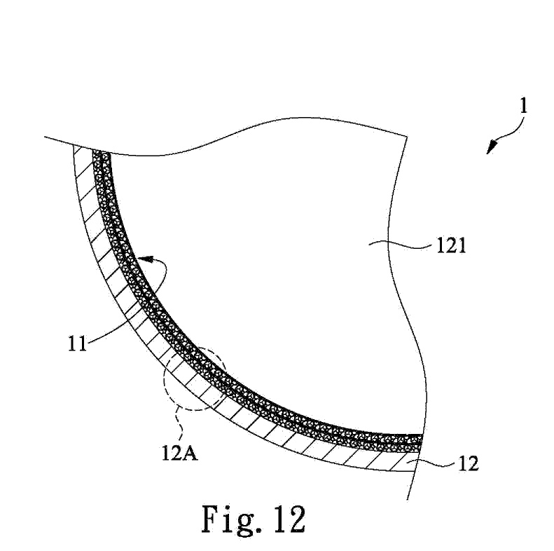

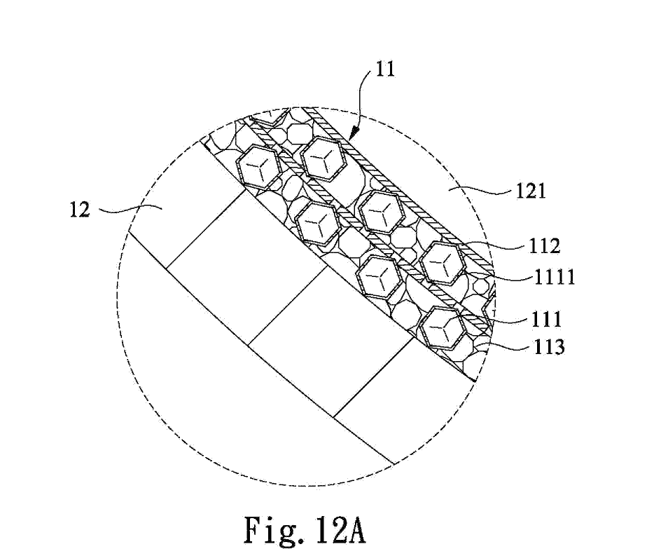

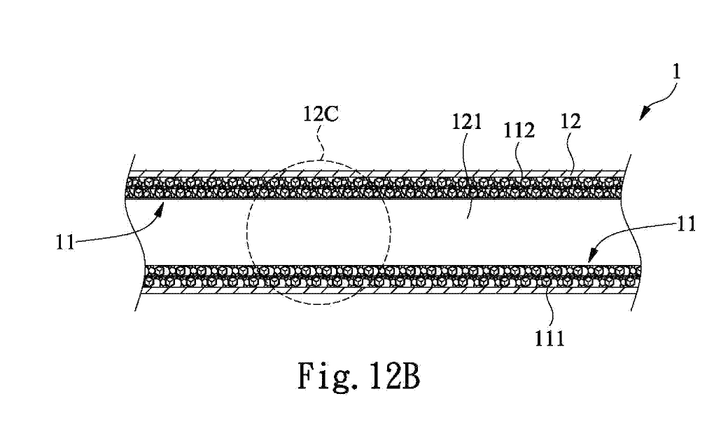

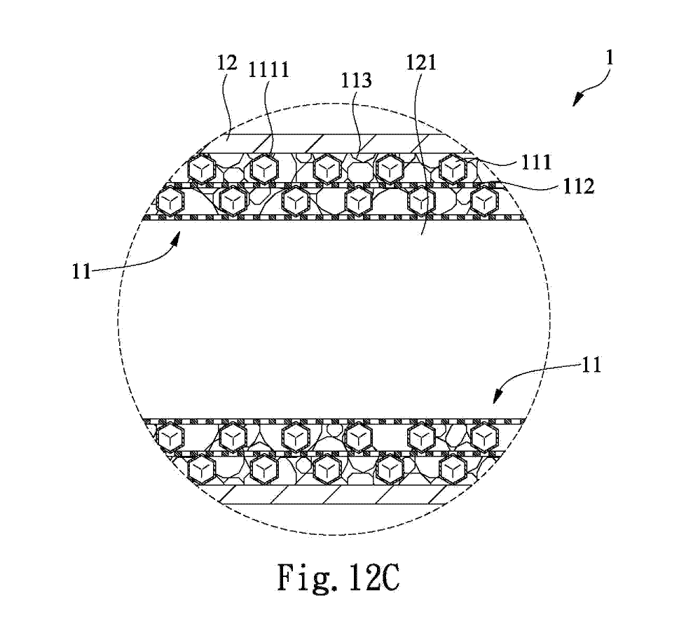

Please refer to FIGS. 1, 2, 11, 11A, 12 and 12A-C. A heat spreader structure 1 according to a fourth embodiment of the present invention includes at least one carbonaceous matter-metal composite layer 11 including a plurality of carbonaceous particles 111, at least one metal-mesh layer 112, and a plurality of metal particles 113 having high thermal conductivity. The carbonaceous particles 111 are externally coated with at least one layer of metal coating 1111, and mixed homogeneously with the metal particles 113 having high thermal conductivity, and the mixture is covered and thereby held in place using the metal-mesh layer 112. The metal particles 113 having high thermal conductivity are selected from the group consisting of copper (Cu), aluminum (Al), silver (Ag), and nickel (Ni) particles, and are preferably copper particles. The metal-mesh layer 112 has a plurality of meshes 1121, and can be made of a material selected from the group consisting of copper (Cu), aluminum (Al), silver (Ag), and nickel (Ni). The carbonaceous particles 111 can be selected from the group consisting of diamond and graphite particles. And, the metal coating 1111 is formed using a material selected from the group consisting of copper (Cu), aluminum (Al), and silver (Ag). In a first example of application, the heat spreader structure 1 of the fourth embodiment is used with at least one metal-made body 12, which is configured as a heat sink, as shown in FIGS. 11 and 11A. In this case, the carbonaceous matter-metal composite layer 11 is attached to an outer face of the metal-made body 12. In a second and a third example of application, the heat spreader structure 1 of the fourth embodiment is used with a hollow metal-made body 12 configured as a heat pipe and a flat heat pipe, respectively, which internally defines a chamber 121, as shown in FIGS. 12 and 12A and FIGS. 12B and 12C, respectively. In these cases, the carbonaceous matter-metal composite layer 11 is attached to an inner wall surface or inner wall surfaces of the chamber 121 of the metal-made body 12. The carbonaceous matter-metal composite layer 11 coated on the outer face of the metal-made body 12 or on the inner wall surface(s) of the chamber 121 of the metal-made body, 12 can include only one single, ply or multiple overlaid plies.

In the above described embodiments, the carbonaceous particles 111, the metal-mesh layer 112, and the metal particles 113 having high thermal conductivity are bonded to one another through sintering in powder metallurgy. By sintering, it means powder is subjected to a thermal treatment under predetermined surrounding conditions and at a temperature below the melting point of the main constituent, so that the particles thereof have reduced surface area and reduced pore volume to bond together. The bonded particles have properties of composite materials. Therefore, the sintered structure provides a porous structure that can be used as the capillary structure inside the heat pipe. Further, it is also possible to apply high temperature and high pressure during the process of sintering, so that the obtained sintered structure does not include pores.

As having been mentioned above, the industrial diamond has thermal conductivity as high as 2300 (W/m·K), and copper has thermal conductivity as high as 401 (W/m·K), both of which have thermal conductivity much higher than other metals. Therefore, the heat spreader structure 1 according to the present invention has good thermal conductivity while it does not involve in high manufacturing cost as the conventional heat spreader structures completely made of the industrial diamond.

The carbonaceous particles 111 in the embodiments of the present invention can have a particle size ranged from 1 μm to 2 mm, and preferably ranged from 100 μm to 150 μm. The meshes 1121 of the metal-mesh layer 112 in the embodiments of the present invention can have a mesh size, ranged from 1 μm to 2 mm and smaller than the particle size of the carbonaceous particles 111, and preferably ranged from 100 μm to 150 μm and smaller than the particle size of the carbonaceous particles 111. In the illustrated embodiments, part of the carbonaceous particles 111 can have a particle size slightly larger than the mesh size of the meshes 1121 of the metal-mesh layer 112, so that these larger carbonaceous particles 111 can be firmly held inside the meshes 1121 of the metal-mesh layer 112. However, it is also acceptable for all the carbonaceous particles 111 to have a particle size larger than the mesh size of the meshes 1121 of the metal-mesh layer 112. In the latter case, the carbonaceous particles 111 are covered and thereby held in place using the metal-mesh layer 112.

FIGS. 5, 5A-C, 8, 8A-C, 10, 10A-C, 12, 12A-C show the carbonaceous matter-metal composite layer 11 forming the heat spreader structure according to different embodiments of the present invention is combined with a metal-made body 12, which is configured as a heat pipe, or a flat heat pipe. That is, the metal-made body 12 internally includes a capillary structure adopting the carbonaceous matter-metal composite layer 11 of the present invention. More particularly, the capillary structure for the metal-made body 12, which is a heat pipe or a flat heat pipe, includes at least one carbonaceous matter-metal composite layer 11, which can include only one single ply or multiple plies and consists of a plurality of carbonaceous particles 111 and at least one metal-mesh layer 112 having a plurality of meshes 1121. The carbonaceous particles 111 can be separately firmly held inside the meshes 1211, or be covered and held in place by the metal-mesh layer 112. Further, the carbonaceous particles 111 can be mixed homogeneously with the plurality of metal particles 113 having high thermal conductivity, and the mixture is evenly distributed over predetermined coating areas on the metal-made body 12 and then covered and held in place on the metal-made body 12 using the metal-mesh layer 12 so that the carbonaceous matter-metal composite layer 11 has a plurality of pores 13 contained therein. Therefore, the carbonaceous matter-metal composite layer 11 can substitute for the conventional capillary structure in the metal-made body 12 configured as a heat pipe or a flat heat pipe. Moreover, since the carbonaceous particles Ill have high thermal coefficient, they are helpful in enhancing the heat transfer performance of the heat pipe or the flat heat pipe.

On the other hand, FIGS. 4, 4A, 7, 7A, 9, 9A, 11 and 11A show the carbonaceous matter-metal composite layer 11 forming the heat spreader structure according to different embodiments of the present invention is combined with a metal-made body 12, which is configured as a heat sink. The metal-made body 12 configured as a heat sink includes at least one heat receiving section 122 and at least one beat spreading section 123. The heat receiving section 122 is in contact with at least one heat source (not shown) to absorb and transfer the heat source to the heat spreading section 123. At least one carbonaceous matter-metal composite layer 11 forming different embodiments of the present invention is provided on an outer face of the heat receiving section 122, and the carbonaceous matter-metal composite layer 11 each can include only one single ply or multiple overlaid plies. The carbonaceous matter-metal composite layer 11 consists of a plurality of carbonaceous particles 111 and at least one metal-mesh layer 112 having a plurality of meshes 1121. The carbonaceous particles 111 can be separately firmly held inside the meshes 1211 of the metal-mesh layer 112, or be covered and held in place by the metal-mesh layer 112. Since the carbonaceous particles 111 of the carbonaceous matter-metal composite layer 11 have high thermal coefficient, the provision of the carbonaceous matter-metal composite layer 11 on the outer face of the heat receiving section 122 can upgrade the heat spreading performance of the metal-made body 12.

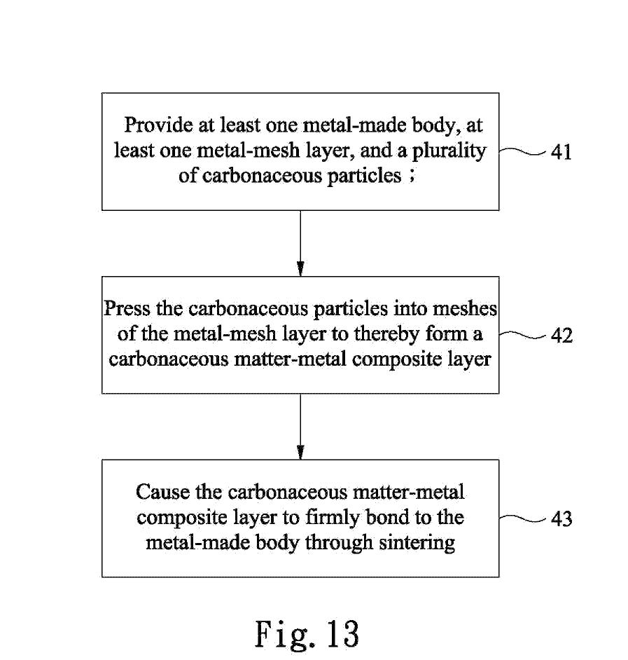

The present invention also provides a method of manufacturing the above-described heat spreader structure. Please refer to FIG. 13 that is a flowchart showing the steps included in a method according to a first embodiment of the present invention for manufacturing the heat spreader structure as shown in FIGS. 1, 2, 3B, 4, 4A, 5 and 5A-C. The steps included in the method of the first embodiment are:

Step 41: providing at least one metal-made body, at least one metal-mesh layer and a plurality of carbonaceous particles. In the step 41, at least one metal-made body 12, at least one metal-mesh layer 112, and a plurality of carbonaceous particles 111 are provided. The metal-made body 12 can be configured as any one of a heat sink as shown in FIG. 4, a heat pipe as shown in FIG. 5, and a flat heat pipe as shown in FIG. 5B. The carbonaceous particles 111 can have a particle size ranged from 1 μm to 2 mm, and preferably ranged from 100 μm to 150 μm. The metal-mesh layer 112 has a plurality of meshes 1121, which can have a mesh size ranged from 1 μm to 2 mm and smaller than the particle size of the carbonaceous particles 111, and preferably ranged from 100 μm to 150 μm and smaller than the particle size of the carbonaceous particles 111;

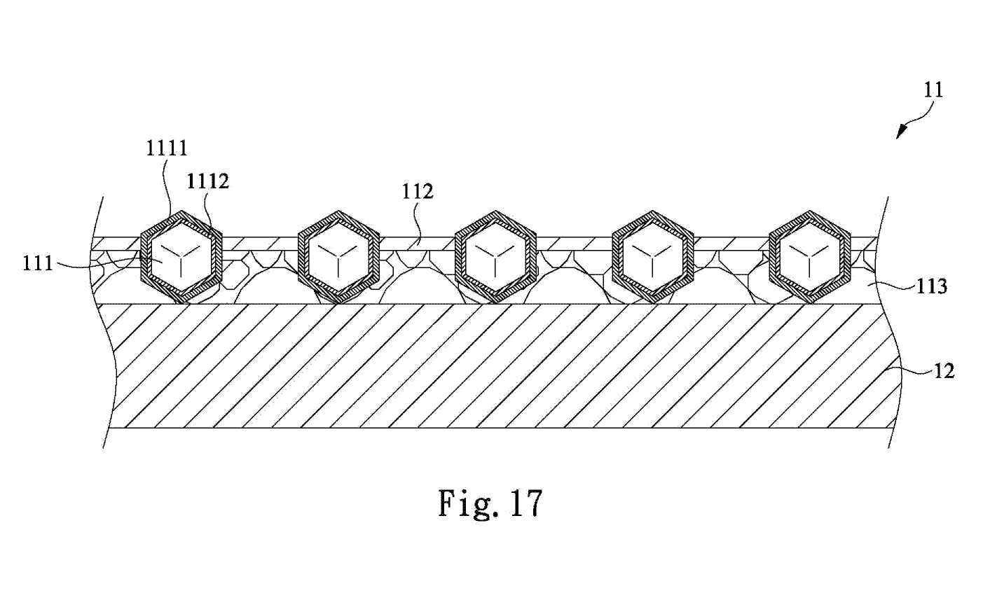

Step 42: Pressing the carbonaceous particles into the meshes of the metal-mesh layer to form a carbonaceous matter-metal composite layer. In the step 42, the carbonaceous particles 111 are evenly distributed over and pressed against the metal-mesh layer 112, so that the carbonaceous particles 111 are separately firmly clamped by and held inside the meshes 1121 of the metal-mesh layer 112 to form a carbonaceous matter-metal composite layer 11 as shown in FIG. 17; and

Step 43: Coating the carbonaceous matter-metal composite layer on one side face of the metal-made body, and causing the carbonaceous matter-metal composite layer to firmly bond to the metal-made body through sintering. In the step 43, the carbonaceous matter-metal composite layer 11 including the carbonaceous particles 111 and the metal-mesh layer 112 is coated on the metal-made body 12 at desired areas. Then, the carbonaceous matter-metal composite layer 11 and the metal-made body 12 are sintered under pressure and heat, so that the carbonaceous matter-metal composite layer 11 is firmly bonded to the metal-made body 12.

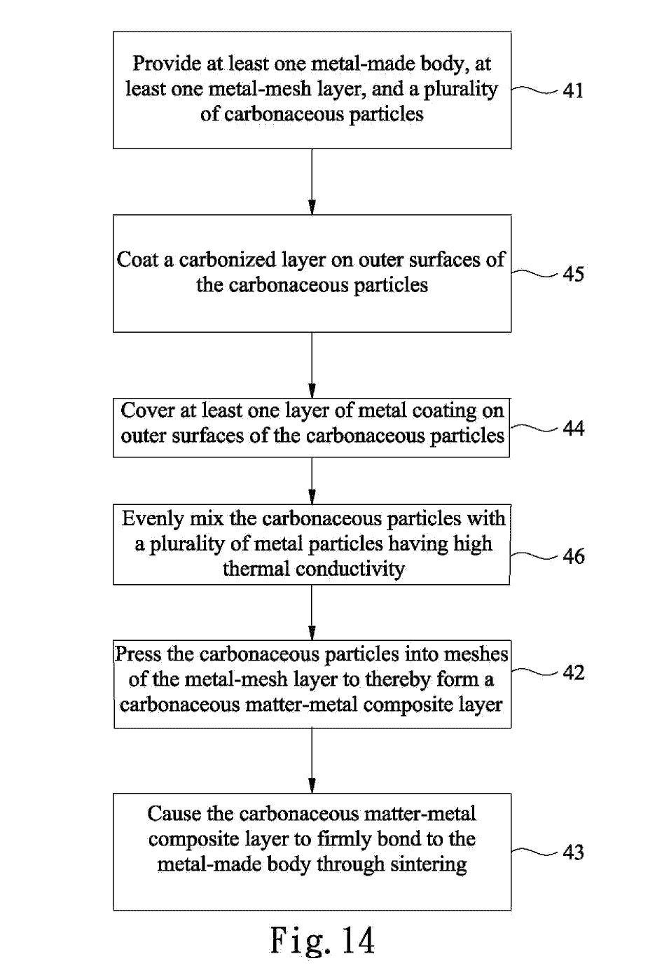

FIG. 14 is a flowchart showing the steps included in a method according to a second embodiment of the present invention for manufacturing the heat spreader structure as shown in FIGS. 1, 2, 3B, 6, 7, 8, 8B, 9, 10, 10B, 11, 12, 12B. In addition to the steps 41, 42 and 43 included in the method of the first embodiment, the method according to the second embodiment of the present invention further includes a step 44 before the step 42 to coat at least one layer of metal coating 1111 on outer surfaces of the carbonaceous particles 111, so as to increase the bonding power of the carbonaceous particles 111 to other metal materials through sintering; a step 45 before the step 44 to coat a carbonized layer 1112 on the outer surfaces of the carbonaceous particles 111, so as to increase the bonding power of the layer of metal coating 1111 to the outer surfaces of the metal coating 1111; and a step 46 after the step 44 to evenly mix the carbonaceous particles 111 with a plurality of metal particles 113 having high thermal conductivity.

FIG. 17 is a sectional view of the heat spreader structure 1 manufactured according to the method according to the second embodiment of the present invention.

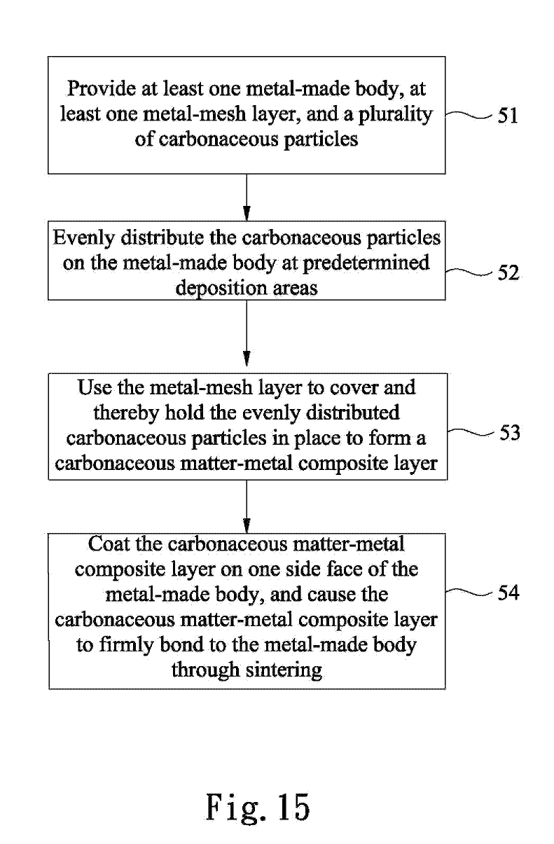

FIG. 15 is a flowchart showing the steps included in a method according to a third embodiment of the present invention for manufacturing the heat spreader structure as shown in FIGS. 1, 2, 3A, 4, 4A, 5 and 5A-C. The steps included in the method of the third embodiment are:

Step 51: providing at least one metal-made body at least one metal-mesh layer and a plurality of carbonaceous particles. In the step 51, at least one metal-made body 12, at least one metal-mesh layer 112, and a plurality of carbonaceous particles 111 are provided. The metal-made body 12 can be configured as any one of a heat sink as shown in FIG. 4, a heat pipe as shown in FIG. 5, and a flat heat pipe as shown in FIG. 5B. The carbonaceous particles 111 can have a particle size ranged from 1 μm to 2 mm, and preferably ranged from 100 μm to 150 μm. The metal-mesh layer 112 has a plurality of meshes 1121, which can have a mesh size ranged from 1 μm to 2 mm and smaller than the particle size of the carbonaceous particles 111, and preferably ranged from 100 μm to 150 μm and smaller than the particle size of the carbonaceous particles 111;

Step 52: Evenly distributing the carbonaceous particles on the metal-made body at predetermined deposition areas. In the step 52, the carbonaceous particles 111 are evenly distributed on the metal-made body 12 at predetermined deposition areas;

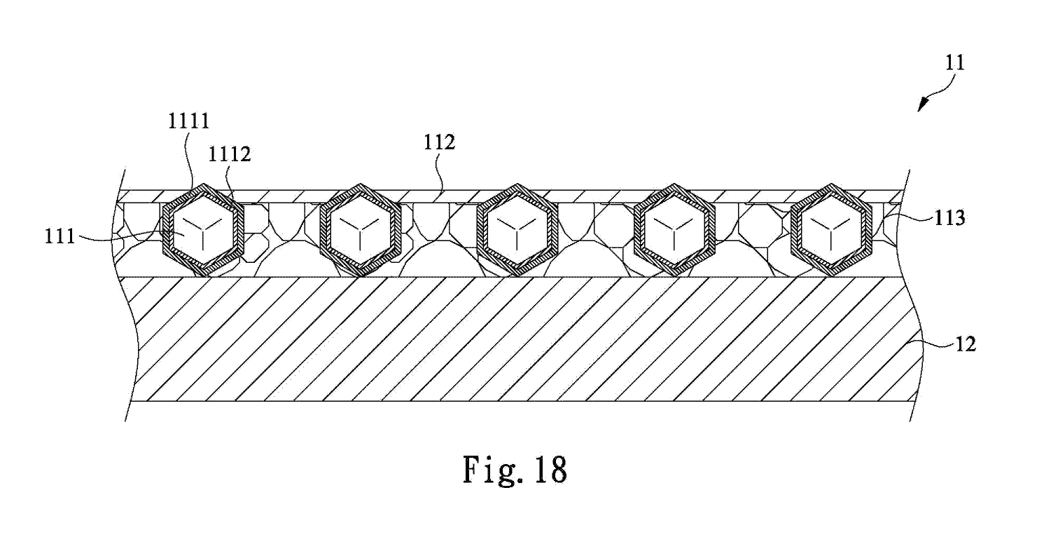

Step 53: Using the metal-mesh layer to cover and thereby hold the evenly distributed carbonaceous particles in place to form a carbonaceous matter-metal composite layer. In the step 53, the carbonaceous particles 111 are covered and held in place using the metal-mesh layer 112, as shown in FIG. 18. Since the meshes 1121 of the metal-mesh lawyer 112 have a mesh size smaller than the particle size of the carbonaceous particles 111, the carbonaceous particles 111 evenly distributed on the metal-made body 12 can be covered and held in place by the metal-mesh layer 112 without the risk of separating from the metal-made body 12 via the meshes 1121, so that a carbonaceous matter-metal composite layer 11 is formed on the metal-made body 12; and

Step 54: Causing the carbonaceous matter-metal composite layer to firmly bond to the metal-made body through sintering. In the step 54, the metal-mesh layer 112 and the metal-made body 12 are sintered, so that the carbonaceous matter-metal composite layer 11 including the metal-mesh layer 112 and the carbonaceous particles 111 is attached to and firmly bonded to the metal-made body 12.

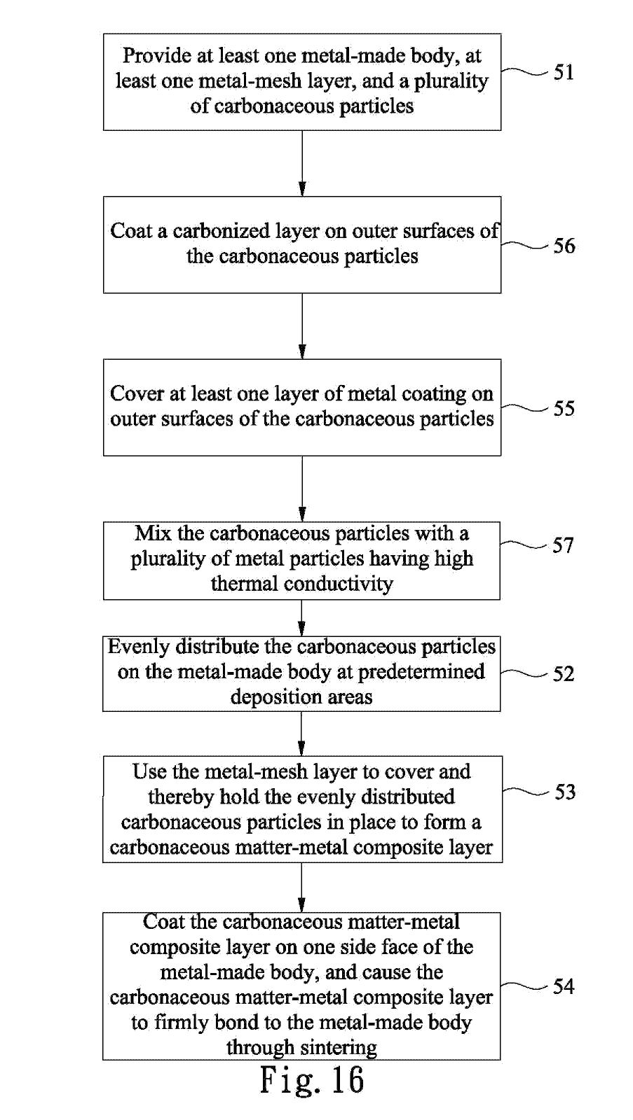

FIG. 16 is a flowchart showing the steps included in a method according to a fourth embodiment of the present invention for manufacturing the heat spreader structure as shown in FIGS. 1, 2, 3A, 6, 7, 8, 8B, 9, 10, 10B, 11, 12, 12B. In addition to the steps 51, 52, 53 and 54 included in the method of the third embodiment, the method according to the fourth embodiment of the present invention further includes a step 55 before the step 52 to coat at least one metal coating 1111 on outer surfaces of the carbonaceous particles 111; a step 56 before the step 55 to form a carbonized layer 1112 on the outer surfaces of the carbonaceous particles 111; and a Step 57 after the step 55 and before the step 52 to mix the carbonaceous particles 111 with a plurality of metal particles 113 having high thermal conductivity.

FIG. 18 is a sectional view of the heat spreader structure 1 manufactured according to the method according to the fourth embodiment of the present invention.

In the methods according to the present invention for forming the heat spreader structure 1, the material for forming the carbonized layer 1112 can be selected from the group consisting of chromium (Cr), titanium (Ti), tungsten (W), molybdenum (Mo), silicon (Si), and vanadium (V); the material for the metal coating 1111 can be selected from the group consisting of copper (Cu), aluminum (Al), and silver (Ag); the carbonaceous particles 111 can be selected from the group consisting of diamond particles and graphite particles; and the metal particles 113 can be selected from the group consisting of copper (Cu), aluminum (Al), silver (Ag), and nickel (Ni) particles, and are preferably copper particles.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A heat spreader structure, comprising at least one carbonaceous matter-metal composite layer including a plurality of carbonaceous particles and at least one metal-mesh layer; the metal-mesh layer having a plurality of meshes, and the carbonaceous particles being either separately firmly held inside the meshes of the metal-mesh layer or covered and held in place by the metal-mesh layer.

2. The heat spreader structure as claimed in claim 1, wherein the carbonaceous particles are selected from the group consisting of diamond and graphite particles.

3. The heat spreader structure as claimed in claim 1, further comprising a metal-made body and the carbonaceous matter-metal composite layer being coated on an outer face of the metal-made body.

4. The heat spreader structure as claimed in claim 1, further comprising a metal-made body, the metal-made body internally defining at least one chamber, and the carbonaceous matter-metal composite layer being attached to inner face(s) of the chamber of the metal-made body.

5. The heat spreader structure as claimed in claim 1, wherein the metal-mesh layer is made of a material selected from the group consisting of copper (Cu), aluminum (Al), silver (Ag), and nickel (Ni).

6. A heat spreader structure, comprising at least one carbonaceous matter-metal composite layer including a plurality of carbonaceous particles and at least one metal-mesh layer; the carbonaceous particles being coated with at least one layer of metal coating, the metal-mesh layer having a plurality of meshes, and the carbonaceous particles being either separately firmly held inside the meshes of the metal-mesh layer or covered and held in place by the metal-mesh layer.

7. The heat spreader structure as claimed in claim 6, wherein the carbonaceous particles are selected from the group consisting of diamond and graphite particles.

8. The heat spreader structure as claimed in claim 6, wherein the metal coating is formed using a material selected from the group consisting of copper (Cu), aluminum (Al); and silver (Ag).

9. The heat spreader structure as claimed in claim 6, further comprising a metal-made body, and the carbonaceous matter-metal composite layer being coated on an outer face of the metal-made body.

10. The heat spreader structure as claimed in claim 6, further comprising a metal-made body, the metal-made body internally defining at least one chamber, and the carbonaceous matter-metal composite layer being attached to inner face(s) of the chamber of the metal-made body.

11. The heat spreader structure as claimed in claim 6, wherein the metal-mesh layer is made of a material selected from the, group consisting of copper (Cu), aluminum (Al), silver (Ag), and nickel (Ni).

12. A heat spreader structure, comprising at least one carbonaceous matter-metal composite layer including a plurality of carbonaceous particles, at least one metal-mesh layer, and a plurality of metal particles having high thermal conductivity; the metal-mesh layer having a plurality of meshes, the carbonaceous particles being mixed homogeneously with the metal particles having high thermal conductivity, and the mixture of the carbonaceous particles and the metal particles being covered and thereby held in place by the metal-mesh layer.

13. The heat spreader structure as claimed in claim 12, wherein the carbonaceous particles are selected from the group consisting of diamond and graphite particles.

14. The heat spreader structure as claimed in claim 12, further comprising a metal-made body, and the carbonaceous matter-metal composite layer being coated on an outer face of the metal-made body.

15. The heat spreader structure as claimed in claim 12, further comprising a metal-made body, the metal-made body internally defining at least one chamber, and the carbonaceous matter-metal composite layer being attached to inner face(s) of the chamber of the metal-made body.

16. The heat spreader structure as claimed in claim 12, wherein the metal-mesh layer is made of a material selected from the group consisting of copper (Cu), aluminum (Al), silver (Ag), and nickel (Ni).

17. A heat spreader structure, comprising at least one carbonaceous matter-metal composite layer including a plurality of carbonaceous particles, at least one metal-mesh layer, and a plurality of metal particles having high thermal conductivity; the carbonaceous particles being coated with at least one layer of metal coating, the metal-mesh layer having a plurality of meshes, and the carbonaceous particles being mixed homogeneously with the metal particles having high thermal conductivity, and the mixture of the carbonaceous particles and the metal particles being covered and thereby held in place by the metal-mesh layer.

18. The heat spreader structure as claimed in claim 17, wherein the carbonaceous particles are selected from the group consisting of diamond and graphite particles.

19. The heat spreader structure as claimed in claim 17, wherein the metal coating is formed using a material selected front the group: consisting of copper (Cu), aluminum (Al), and silver (Ag).

20. The heat spreader structure as claimed in claim 17, further comprising a metal-made body, and the carbonaceous matter-metal composite layer being coated on an outer face of the metal-made body.

21. The heat spreader structure as claimed in claim 17, further comprising a metal-made body, the metal-made body internally defining at least one chamber, and the carbonaceous matter-metal composite layer being attached to inner face(s) of the chamber of the metal-made body.

22. The heat spreader structure as claimed in claim 17, wherein the metal-mesh layer is made of a material selected from the group consisting of copper (Cu), aluminum (Al), silver (Ag), and nickel (Ni).

23. A method of manufacturing heat spreader structure, comprising the following steps:
providing at least one metal-made body, at least one metal-mesh layer, and a plurality of carbonaceous particles;
pressing the carbonaceous particles into meshes of the metal-mesh layer to form a carbonaceous matter-metal composite layer; and
coating the carbonaceous matter-metal composite layer on one face of the metal-made body, and bonding the carbonaceous matter-metal composite layer to the metal-made body firmly by sintering.

24. The method of manufacturing heat spreader structure as claimed in claim 23, further comprising a step before the pressing step to coat at least one layer of metal coating on outer surfaces of the carbonaceous particles.

25. The method of manufacturing heat spreader structure as claimed in claim 24, further comprising a step before the coating step to form a carbonized layer on outer surfaces of the carbonaceous particles.

26. The method of manufacturing heat spreader structure as claimed in claim 25, wherein the carbonized layer is formed from a material selected from the group consisting of chromium (Cr), titanium (Ti), tungsten (W), molybdenum (Mo), silicon (Si), and vanadium (V).

27. The method of manufacturing heat spreader structure as claimed in claim 24, wherein the metal coating is formed using a material selected from the group consisting of Copper (Cu), aluminum (Al), and silver (Ag).

28. The method of manufacturing heat spreader structure as claimed in claim 23, wherein the carbonaceous particles are selected from the group consisting of diamond and graphite particles.

29. The method of manufacturing heat spreader structure as claimed in claim 23, further comprising a step before the pressing step to mix the carbonaceous particles homogeneously with a plurality of metal particles with high thermal conductivity.

30. A method of manufacturing heat spreader structure, comprising the following steps:
providing at least one metal-made body, at least one metal-mesh layer, and a plurality of carbonaceous particles;
distributing the carbonaceous particles to the metal-made body homogeneously on the predetermined deposition areas;
using the metal-mesh layer to cover and thereby hold the evenly distributed carbonaceous particles in place to form a carbonaceous matter-metal composite layer on the metal-made body; and
bonding the carbonaceous matter-metal composite layer firmly to the metal-made body by sintering.

31. The method of manufacturing heat spreader structure as claimed in claim 30, wherein the carbonaceous particles are selected from the group consisting of diamond and graphite particles.

32. The method of manufacturing heat spreader structure as claimed in claim 30, further comprising a step before the distributing step to coat at least one layer of metal coating on outer surfaces of the carbonaceous particles.

33. The method of manufacturing heat spreader structure as claimed in claim 32, wherein the metal coating is formed using a material selected from the group consisting of copper (Cu), aluminum (Al), and silver (Ag).

34. The method of manufacturing heat spreader structure as claimed in claim 30, wherein the metal-made body internally defines a chamber, and the carbonaceous matter-metal composite layer is attached to inner face(s) of the chamber of the metal-made body.

35. The method of manufacturing heat spreader structure as claimed in claim 30, wherein the metal-mesh layer is made of a material selected from the group consisting of copper (Cu), aluminum (Al), silver (Ag), and nickel (Ni).

36. The method of manufacturing heat spreader structure as claimed in claim 30, wherein further comprising a step before the step of distributing the carbonaceous particles and after the coating step to mix the carbonaceous particles homogeneously with a plurality of metal particles with high thermal conductivity.

37. The method of manufacturing heat spreader structure as claimed in claim 32, further comprising a step before the coating step to form a carbonized layer on outer surfaces of the carbonaceous particles.
